(19) United States
(12) Patent Application Publication
(10) Pub. No.: US 2013/0226448 A1
(43) Pub. Date: Aug. 29, 2013

(54) METHOD FOR DETECTING GRADE SEPARATED CROSSINGS AND UNDERPASSES

(71) Applicant: Tim Bekaert, Kluisbergen (BE)

(72) Inventor: Tim Bekaert, Kluisbergen (BE)

(21) Appl. No.: 13/881,862

(22) PCT Filed: Oct. 26, 2010
(86) PCT No.: PCT/EP10/66121

§ 371 Date: Apr. 26, 2013

(51) Int. Cl. G01C 21/26

(52) U.S. Cl. CPC G01C 21/26
USPC 701/409

(57) ABSTRACT

A method for determining the existence of an underpass (21) in a digital map by observing probe data is provided. The method includes providing a digital map having at least two road segments (18, 20) and reporting data from a plurality of probe traces traveling along the at least two roads segment (18, 20). Further, analyzing the reported data for dilution of precision (DOP) values. Then, inferring the existence of an underpass (21) along one (18) of the at least two road segments (18, 20) if the DOP values suddenly decrease from a substantially constant value to a decreased value and then suddenly return to the substantially constant value.

### BACKGROUND OF THE INVENTION

1. Field of the Invention

This invention relates generally to digital maps of the type for displaying road or pathway information, and more particularly to a method for detecting grade separated crossings, underpasses and tunnels for incorporation in a digital map.

2. Related Art

Personal navigation devices like that shown, for example, in FIG. 1 utilize digital maps combined with accurate positioning data from GPS or other data streams. These devices have been developed for many applications, such as navigation assistance for automobile drivers. The effectiveness of these devices is inherently dependent upon the accuracy of the information provided to them in the form of digital maps, stored in their memory or otherwise accessed through a suitable database connection such as wireless signal, cable, telephone line, etc.

Typically, the navigation device 10 (FIG. 1) includes a display screen 12 that portrays a portion of a stored digital map as a network of roads 14. A traveler having access to the GPS-enabled navigation device 10 may then be generally located on the digital map close to or with regard to a particular road 14 or segment thereof. Some GPS-enabled navigation devices 10, such as several models manufactured by TomTom NV (www.tomtom.com), may also be configured as probes to passively generate probe measurement points, also referred to as probed traces, at intervals of time, such as randomly spaced, irregular or regular intervals. Such probe traces comprise a sequence of discrete geo-coded positions recorded at, for example, regular intervals of five seconds. Of course, other suitable devices may be used to generate probe measurement points including, for example, handheld devices, mobile phones, PDAs, and the like. Thus, probe data may be described as a set of information pertaining to movement of a vehicle (or a person carrying a probe device) which contains time-stamped geo-coding (geographic locations identified by latitude/longitude coordinates) and possibly also metadata (vehicle speed, receiver type, vehicle type, precision, source, accuracy, etc.).

It is known to take collections of probe measurements for the purpose of incrementally creating and/or updating digital maps. The probe measurements can be transmitted real-time or subsequent monitoring, such as to a collection service or other map data analysis service via wireless (e.g., cellular) transmission, internet uploads, or by other convenient communication methods. Internet uploads may be synchronized to occur in conjunction with digital map upgrades which navigation device users might obtain as part of a service. From the collection of probe measurements, road geometries can be inferred and other features and attributes derived by appropriate analytical methods.

A typical collection of probe measurements collected from a plurality of probes traversing a particular section of a digital map over a period of time may contain billions of discrete data points, each geo-coded and time stamped. Probe traces collected over time can be grouped according to those which match with a common area of the digital map and then overlaid for interpretation by map database editors. These editors use various mathematic and statistical techniques to determine or infer road geometries, compute speed profiles, acceleration profiles, direction of travel, altitude, detect changes in road networks, to compare two road networks, and many other specifications.

As suggested above, the effectiveness of a personal navigation device 10 depends upon the accuracy of the information contained in the digital map. As such, digital map providers continuously strive to improve and update their maps in as efficient and economical manner as possible. However, in making attempts to be efficient and economical, inaccurate data can be obtained. Inaccurate data, for example, may be compromise the ability of the navigation device 10 to compute optimal routes in response to a navigation query, or to provide other reliable information to a traveler. Thus, the inaccurate or incomplete information contained in a digital map can result in poor or erroneous navigation instructions and lead to undesirable navigation decisions. For example, some vehicles, e.g. specialty vehicles including fuel trucks, volatile material hauling vehicles, and oversized vehicles, need to navigate routes generally free of obstacles, e.g. low bridges or tunnels, and bridges capable of carrying the weight of the vehicle load. Accordingly, for some travelers, it is imperative that the digital maps accurately depict the roads and their features. Thus, the existence or nonexistence of a bridge or tunnel constitutes an important detail to be accurately recorded in a digital map.

Until now, methods used to accurately determine whether a route includes a grade separated crossing (i.e. combination overpass/underpass), underpass or a tunnel require obtaining a large quantity of traces using altitude data of the traces, wherein each trace point is analyzed to obtain a distribution of altitude points using statistical methods, e.g., Gaussian distributions on the altitude point distribution. However, performing this detailed analysis requires first, the altitude information be available; second, the altitude information to be of sufficient resolution; third, the altitude information to be reliable, and lastly, the altitude data needs to be precisely located, and not lagged behind the direction of movement due to smoothing effects of GPS receivers. Therefore, there is a need in the art for an improved method for efficiently obtaining accurate data regarding the precise locations of grade separated crossings and tunnels in an economical manner.

### SUMMARY OF THE INVENTION

This invention relates to methods and techniques for obtaining accurate data regarding the precise locations of grade separated crossings and tunnels. The method provides a system that enables probe data to be efficiently collected and accurately evaluated to determine the existence and precise locations of a grade separated crossings and tunnels. The method includes a digital map having at least one of two grade separated road segments crossing one another or a road segment traversing a tunnel. The method further includes reporting data via a plurality of probe traces from a GPS-enabled device traversing the road segments, wherein the reported data includes dilution of precision (DOP) values. Then, the method includes collecting the probe traces and analyzing them to determine where the DOP values are relatively strong and where they are relatively weak. Then, the method includes associating the location of a grade separated crossing or tunnel via the detected weak DOP values.

In accordance with another aspect of the invention, a method for determining an underpass existence in a digital map by observing probe data is provided. The method includes the steps of providing a digital map having at least one road segment and reporting data from a plurality of probe traces traveling along the at least one road segment. Further, analyzing the reported data for dilution of precision (DOP) values, and then, inferring the existence of an underpass along the at least one road segment if the DOP values suddenly decrease from a substantially constant value to a decreased value and then suddenly return to the substantially constant value.

Principles of this invention can be used to effectively locate grade separated road crossings and underpasses where relatively low DOP values exist along a digital map. The low DOP values indicate obstruction of the respective signal owing to an overhead structural obstruction of some sort. Further, the road comprising the overpass and the road comprising the underpass can be readily determined by analyzing the respective traces for their DOP values. Further, if a single road is being analyzed, the relatively low DOP values can be reliably attributed to an underpass. Accordingly, this invention enables a new use for information obtained from community input or other probe measurement collection techniques to economically and reliably detect grade separated crossing and underpasses.

### BRIEF DESCRIPTION OF THE DRAWINGS

These and other aspects, features and advantages will be readily apparent to those skilled in the art in view of the following detailed description of presently preferred embodiments and best mode, appended claims, and accompanying drawings, in which:

FIG. 1 is an exemplary view of a portable navigation device according to one embodiment of this invention including a display screen for presenting map data information;

FIG. 2 is a highly simplified plan view of a digital map having a grade separated crossing (e.g., two roads crossing one another via a bridge);

FIG. 3 is a view of the digital map in FIG. 2 overlaid with general DOP signal strength received via probe data via GPS-enabled devices traveling along the respective roads;

FIG. 4 is a graph of the DOP values from collected probe data via GPS-enabled devices traveling along one of the roads of the digital map of FIG. 2; and

FIG. 5 is a highly simplified plan view of a road traversing an underpass overlaid with general DOP signal strength received via probe data via GPS-enabled devices traveling along the respective roads.

### DETAILED DESCRIPTION OF PREFERRED EMBODIMENTS

Referring in more detail to the drawings, wherein like numerals indicate like or corresponding parts throughout the several views, this invention pertains generally to digital maps as used by navigation systems and devices 10, as well as other map applications which may include those viewable through internet enabled computers, PDAs, cellular phones, and the like.

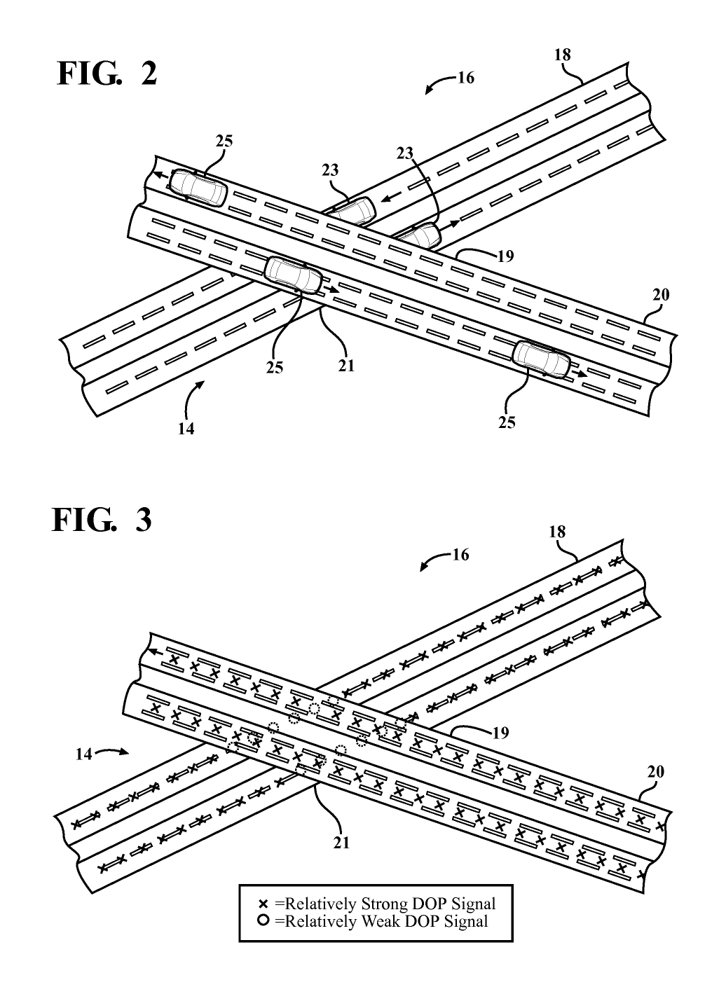

FIG. 2 depicts, in highly simplified form, a grade separated crossing 16 in the form of a plurality of roads, shown as a pair of roads 18, 20. Of course, there are many different possible configurations of grade separated crossings, with only a simplified embodiment be discussed and shown, by way of example and without limitation. Accordingly, the different possible configurations of grade separated crossings not discussed or shown in detail are intended to be included within the definition of grade separated crossing 16, such as multiple roads, bridges, railways, tunnels or variations combinations thereof which overlie one another at least in part.

In the FIG. 2 example, the road segments 18, 20 comprise those portions of an overall road network 14 contained in a digital map. Typically, the road segments 18, 20 will be of the type capable of supporting vehicular traffic flow, such as shown with automobiles 23, 25, although the principles of this invention are equally applicable to other modes of transportation as well.

The road segments 18, 20, as is typical where the travel of vehicles thereon is intended to flow in a substantially uninterrupted manner, are configured at least partially along separate grades, such that one road segment 18 underlies the other road segment 20. Accordingly, one of the road segments 20 extends over a bridge portion 19 in overlying relation to provide an overpass to an underlying underpass portion of the other road segment 18. It is important for some travelers to be made aware of whether a crossing represents a common grade crossing, or a grade separated crossing, such as, for example, overpass bridges and underpasses. In the former case, vehicles may need to know if they can make necessary turns along a common grade crossing, or in the latter case, the vehicles may need to be aware of any road load capacity requirements, bridge height requirements, width requirements, or the like, for example. As such, having advance notification of common grade crossing or a grade separated crossing, e.g., a bridge or other type of grade separated crossing, can prove to be of great importance in mapping a travel route for some travelers.

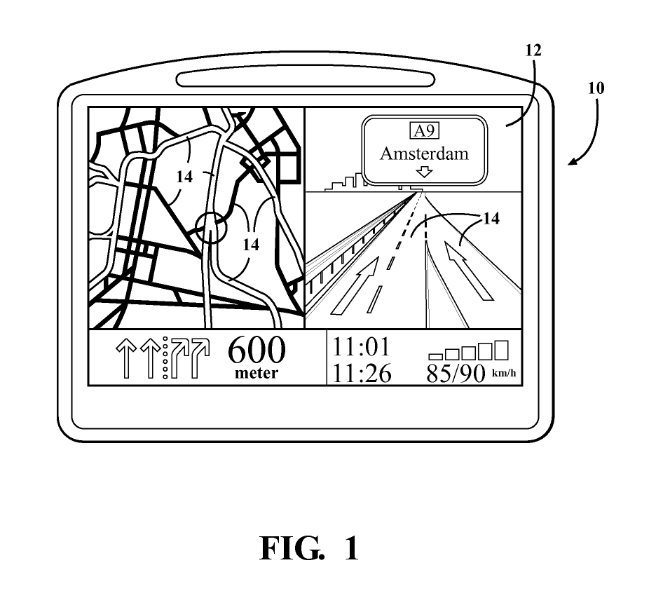

FIG. 3 is a view of the same section of digital map as presented in FIG. 2, but with overlay data from probe traces as collected from vehicles with appropriately enabled probe devices, such as the device 10 of FIG. 1. A plurality of probe traces can be observed from the reported data from the vehicles 23, 25 traveling along the road segments 18, 20. This reported data includes DOP values, perhaps as metadata, or enable the derivation of velocity information by the time-stamped position measurements embodied in each probe trace, for example. From the DOP values, in accordance with the invention, it is possible to detect the grade separated crossing 16 of the road segments. In this particular example, the reported DOP values (transmitted from vehicles 25 traversing the overpass) remain constant or substantially constant across one of the segments 20, while the reported DOP values (transmitted from vehicles 23 traversing the underpass) decrease dramatically from a substantially constant value over a small portion of the other road segment 18, that constituting the underpass, and then return suddenly to the substantially constant value (see legend indicating (x) and (o) relative signal strength). Accordingly, it can be readily inferred that the change in DOP values indicates an obstruction to the reported signals transmitted from the vehicles 23, given the decreased DOP values occur repeatedly in the same detected geo-coded location of the road segment 18.

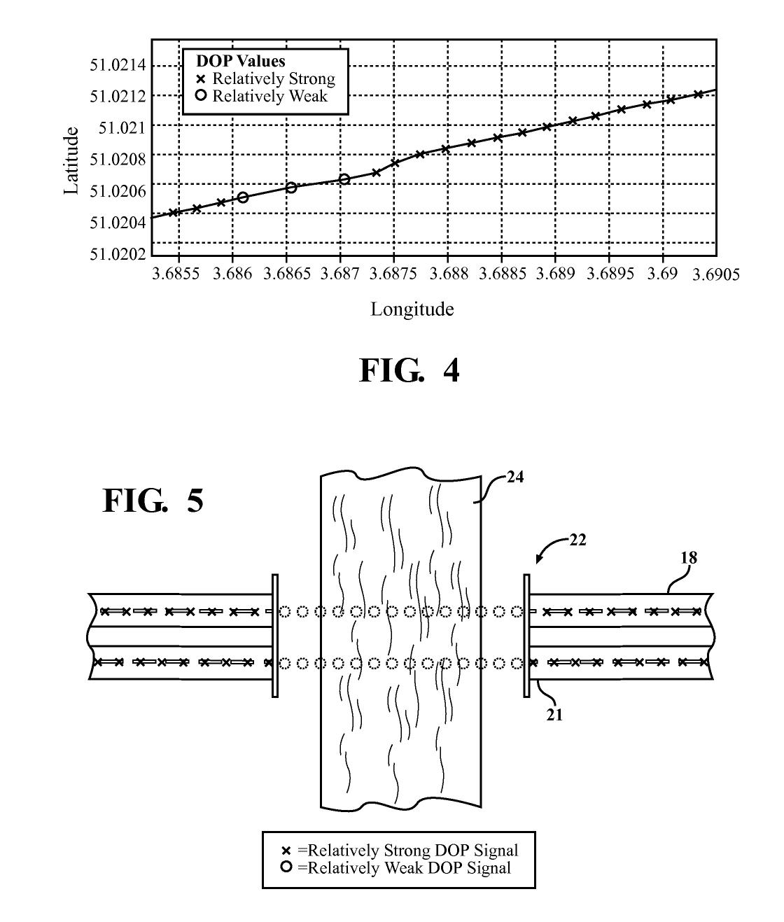

As shown in FIG. 4 in line graph form, the DOP values received along the road segment can be attributed to a precise geo-coded position (latitude and longitude). Accordingly, when the DOP values remain substantially constant over time, whether indicating a strong signal or a weak signal, it can be concluded that what ever is impacting the DOP value is a fixed barrier, and not a temporary obstruction. Further, in a case where separate road segments 18, 20 cross one another, if DOP values remain relatively constant and strong along one road segment 20, it can be concluded that nothing is impeding the signal strength being received, and thus, that nothing is overlying the road segment 20 or otherwise presenting a barrier to the received signal. However, if the DOP values are temporarily poor along the other road segment 18, changing from a relatively strong signal, to a relatively weak signal, and then suddenly returning to a relatively strong signal, then it can be readily concluded that the road segment 18 has a temporary overhead obstruction, thus indicating that the road segment 18 passes beneath a bridge portion of the other road segment 20.

It will therefore be appreciated that the DOP value distribution for probe traces from vehicles traveling along roads that cross at a regular crossing will typically have a single peak. Meanwhile, the DOP value distribution for the lower road at a grade separated crossing, i.e. the DOP values of traces from vehicles going inside a tunnel, underneath a bridge, etc, will typically have two distinguishable peaks. Accordingly, and by way of example, the DOP value distributions associated with crossing roadways can be fitted with Gaussian distributions and the respective means of these distributions compared to determine if the roadways cross each other at a regular or a grade separated crossing.

As shown in FIG. 4, the DOP values received can be geo-coded. Thus, the location identified by the particular latitude and longitude of a trace signal can be plotted, and over time, a trend is established. As such, the strong and weak DOP values received can be monitored to see if an anomaly is present, or contrarily, if a continuous pattern is present. In the example shown, a continuous pattern of a weak DOP value is plotted along a portion of road segment 18, thereby reliably indicating an underpass beneath the overlying bridge portion of the road segment 20.

As shown in FIG. 5, the method in accordance with the invention can be applied to detect the presence of not only of grade separated crossings, but also of a tunnel 22. Using the same logic discussed above, standard DOP values readily available from GPS-enabled navigation systems or devices 10, as well as other map applications, can be collected and analyzed to assess whether a road 18 traverses a tunnel, such as the tunnel 22 depicted providing an underpass 21 traversing a river 24. As with a bridge, when a vehicle equipped with appropriately enabled probe devices travels through the tunnel 22, the DOP values decrease immediately upon entering the tunnel 22, and then return immediately to relatively increased values.

Of course, although not required, it should be recognized that the DOP values received can be combined with a variety of other types of information to further enhance the ability to represent an accurate digital map, such as standard altitude data, for example, and to assist with routing operations on the digital map.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A method for detecting a grade separated crossing in a digital map using probe data, said method comprising the steps of:
providing a digital map having at least two road segments crossing one another;
obtaining data from a plurality of probe traces traveling along the at least two road segments at least over a crossing portion of the road segments, said data comprising dilution of precision (DOP) values for a plurality of locations along the at least two road segments;
comparing the DOP values for the at least two road segments; and
determining the presence or absence of a grade separated crossing between the at least two road segments based on said comparison.

2. The method of claim 1, comprising:
inferring a grade separated crossing between the at least two road segments if the DOP values for at least one of the at least two road segments decreases, and then increases, at or in the vicinity of the crossing portion of the road segments.

3. The method of claim 1, wherein the obtained data comprises altitude data, and said method further includes:
associating the DOP value for a location with an altitude value for the location.

4. The method of claim 1, wherein the obtained data comprises geo-coded data, and said method further includes:
associating the DOP value for a location with the latitude and longitude for the Location.

5. The method of claim 1, wherein said comparing the DOP values for the at least two road segments comprises:
comparing the distribution of DOP values obtained for each of the at least two road segments.

6. The method of claim 5, comprising:
fitting a Gaussian distribution to the distribution of DOP values obtained for each of the at least two road segments;
determining a mean for each of Gaussian distributions; and
comparing the means to determine at least one of the presence and absence of a grade separated crossing between the at least two road segments.

7. The method of claim 1, wherein said probe traces are generated by a plurality of vehicles, that each comprise a location-determining device, and that travel over the at least two road segments.

8. The method of claim 1, wherein said grade separated crossing is selected from the group consisting of: (i) a tunnel; and (ii) an underpass.

9. The method of claim 1, wherein the obtained data comprises altitude data, and said method further includes:
associating all obtained DOP values with the altitude value for the respective locations.

10. The method of claim 1, wherein the obtained data comprises geo-coded data, and said method further includes:
associating all obtained DOP values with the latitude and longitude for the respective locations.

11. The method of claim 1, comprising:
inferring a grade separated crossing between the at least two road segments if the DOP values for at least one of the at least two road segments decreases from a substantially constant value to a decreased value, and then increases to return to the substantially constant value, at or in the vicinity of the crossing portion of the road segments.

12. The method of claim 7, wherein said plurality of vehicles comprise a plurality of motor vehicles.

13. The method of claim 7, wherein the location-determining device in each of the plurality of vehicles comprises a GPS-enabled device.
